(19) United States
(12) Patent Application Publication
(10) Pub. No.: US 2015/0113541 A1
(43) Pub. Date: Apr. 23, 2015

(54) ELECTRONIC DEVICE CAPABLE OF MANAGING INFORMATION TECHNOLOGY DEVICE AND INFORMATION TECHNOLOGY DEVICE MANAGING METHOD

(71) Applicant: Hon Hai Precision Industry Co., Ltd., New Taipei (TW)

(72) Inventor: CHENG-HSIU YANG, New Taipei (TW)

(73) Assignee: HON HAI PRECISION INDUSTRY CO., LTD., New Taipei (TW)

(21) Appl. No.: 14/108,215

(22) Filed: Dec. 16, 2013

(30) Foreign Application Priority Data
Oct. 21, 2013 (TW) 102137971

(51) Int. Cl. G06F 9/46

(52) U.S. Cl. CPC G06F 9/46
USPC 718/105

(57) ABSTRACT

An IT device managing method is applied for an electronic device. The electronic device can communicate with a number of IT devices. The method includes the following steps. Periodically obtaining a temperature of each IT device, determining a load of each IT device corresponding to the obtained temperature and comparing each determined load with a preset value to determine the load of which IT device is greater than or equal to the preset value and determine the load of which IT device is less than the preset value. Obtaining a job currently run by the IT device that has a load greater than the preset value, and control the IT device to stop running the job. Controlling one IT device that has a load less than the preset value to run the job obtained from the IT device that has a load greater than or equal to the preset value.

### BACKGROUND

1. Technical Field

The present disclosure relates to electronic devices, and particularly to an electronic device capable of managing information technology (IT) device and an IT device managing method adapted for the electronic device.

2. Description of Related Art

An Internet job center (IDC) usually includes a number of IT devices, such as servers, storages, and switches. The load of each IT device may be changed, which may cause the IT device to be suddenly shut down or crash if the load becomes too great.

Therefore, what is needed is a means to solve the problem described above.

### BRIEF DESCRIPTION OF THE DRAWINGS

Many aspects of the present disclosure should be better understood with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of an electronic device capable of managing IT devices, in accordance with an exemplary embodiment.

FIG. 2 is a flowchart of an IT device managing method, in accordance with an exemplary embodiment.

### DETAILED DESCRIPTION

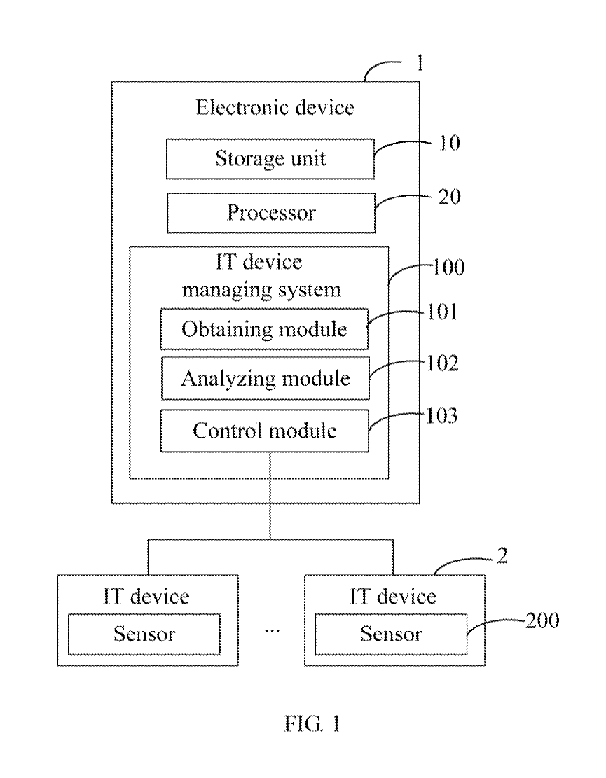

FIG. 1 is a block diagram of an electronic device 1 according to an exemplary embodiment. The electronic device 1, such as servers and computer terminals, can communicate with a number of IT devices 2 via a wireless access port or a wired access port (not shown). The change of load of each IT device 2 is directly proportional to the change of the temperature of the IT device 2. Each IT device 2 includes a temperature sensor 200 arranged within the IT device 2 to detect the temperature of the IT device 2.

The electronic device 1 includes a storage unit 10 and a processor 20. The storage unit 10 stores a relationship between loads of different IT devices 2 and temperatures each corresponding to one load. The storage unit 10 further stores an IT device managing system 100. The system 100 includes a variety of modules executed by the processor 20 to provide the functions of the system 100. A detailed description of the variety of modules will be described as follows.

The system 100 includes an obtaining module 101, an analyzing module 102, and a control module 103.

The obtaining module 101 periodically (e.g., every two minutes) obtains the temperature of each IT device 2 detected by the sensor 200 of each IT device 2.

The analyzing module 102 determines the load of each IT device 2 corresponding to the obtained temperature according to the relationship stored in the storage unit 10. In addition, the analyzing module 102 compares each determined load with a preset value to determine the load of which IT device 2 is greater than or equal to the preset value and determine the load of which IT device 2 is less than the preset value.

The control module 103 obtains a job that is being currently run by the IT device 2 that has a load greater than the preset value, here the job is a task or work being currently performed by the IT device 2, and possibly the cause of overloaded IT device 2. The control module 103 then controls the IT device 2 to stop running the job to decrease the load of the IT device 2.

The control module 103 further controls one IT device 2 that has a load less than the preset value to run the job obtained from the IT device 2 that has a load greater than or equal to the preset value.

In the embodiment, the analyzing module 102 determines a first number of IT devices 2 each has a load greater than or equal to the preset value (hereinafter, first IT devices), and determines a second number of IT devices 2 each has a load less than the preset value (hereinafter, second IT devices). If the first number is equal to the second number, the control module 103 controls each second IT devices 2 to run the job obtained from one first IT device 2. If the first number is greater than the second number, the control module 103 determines the second IT device 2 having the least load. Then, the control module 103 controls each of the second IT devices 2 except the second IT device 2 having the least load to run the job obtained from one first IT device 2, and controls the second IT device 2 having the least load to run the job obtained from the remaining IT devices 2. If the first number is less than the second number, the control module 103 sorts all the second IT devices 2 in a sequence according to the load of each second device 2. The second device 2 having the least load is arranged first in the sequence. The control module 103 controls each of the second devices 2 in front of the sequence to run the job obtained from one first IT device 2.

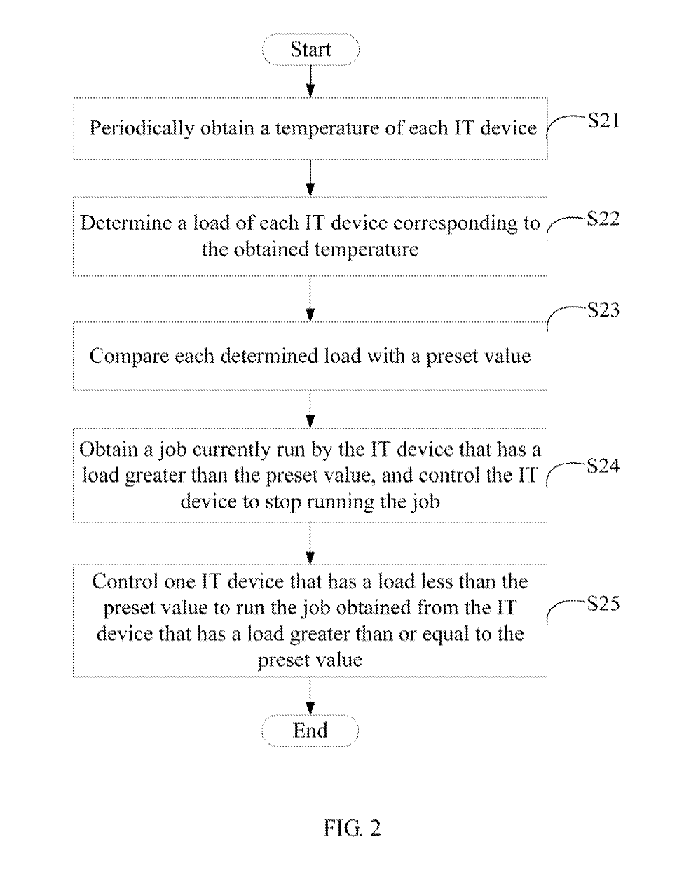

FIG. 2 is a flowchart of an IT device managing method, in accordance with an exemplary embodiment.

In step S21, the obtaining module 101 periodically obtains the temperature of each

IT device 2 detected by the sensor 200 of each IT device 2.

In step S22, the analyzing module 102 determines the load of each IT device 2 corresponding to the obtained temperature according to the relationship stored in the storage unit 10.

In step S23, the analyzing module 102 compares each determined load with a preset value to determine the load of which IT device 2 is greater than or equal to the preset value and determine the load of which IT device 2 is less than the preset value.

In step S24, the control module 103 obtains the job currently run by the IT device 2 that has a load greater than the preset value, and controls the IT device 2 to stop running the job to decrease the load of the IT device 2.

In step S25, the control module 103 controls one IT device 2 that has a load less than the preset value to run the job obtained from the IT device 2 that has a load greater than or equal to the preset value.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device capable of communicating with a plurality of IT devices, the electronic device comprising:
a storage unit storing a relationship between loads of different IT devices and temperatures each corresponding to one of the loads; and
a processor to execute a plurality of modules,
wherein the plurality of modules comprises:
an obtaining module to periodically obtain a temperature of each IT device;
an analyzing module to determine a load of each IT device corresponding to the obtained temperature according to the relationship stored in the storage unit, and compare each determined load with a preset value to determine the load of which IT device is greater than or equal to the preset value and determine the load of which IT device is less than the preset value; and
a control module to obtain a job currently run by the IT device that has a load greater than the preset value, and control the IT device to stop running the job; and to further control one IT device that has a load less than the preset value to run the job obtained from the IT device that has a load greater than or equal to the preset value.

2. The electronic device of claim 1, wherein the analyzing module is configured to determine a first number of first IT devices each has a load greater than or equal to the preset value, and determine a second number of second IT devices each has a load less than the preset value, if the first number is equal to the second number, the control module is configured to control each second IT devices to run the job obtained from one first IT device.

3. The electronic device of claim 1, wherein the analyzing module is configured to determine a first number of first IT devices each has a load greater than or equal to the preset value, and determine a second number of second IT devices each has a load less than the preset value, if the first number is greater than the second number, the control module is configured to determine one second IT device having a least load, control each of the second IT devices except the second IT device having the least load to run the job obtained from one first IT device, and control the second IT device having the least load to run the job obtained from the remaining IT devices.

4. The electronic device of claim 1, wherein the analyzing module is configured to determine a first number of first IT devices each has a load greater than or equal to the preset value, and determine a second number of second IT devices each has a load less than the preset value, if the first number is less than the second number, the control module is configured to sort all second IT devices in a sequence according to the load of each second device, and control each of the second devices in front of the sequence to run the job obtained from one first IT device.

5. An IT device managing method applied for an electronic device, the electronic device capable of communicating with a plurality of IT devices, the electronic device comprising a storage unit storing a relationship between loads of different IT devices and temperatures each corresponding to one of the loads, the method comprising:
periodically obtaining a temperature of each IT device;
determining a load of each IT device corresponding to the obtained temperature according to the relationship stored in the storage unit;
comparing each determined load with a preset value to determine the load of which IT device is greater than or equal to the preset value and determine the load of which IT device is less than the preset value;
obtaining a job currently run by the IT device that has a load greater than the preset value, and control the IT device to stop running the job; and
controlling one IT device that has a load less than the preset value to run the job obtained from the IT device that has a load greater than or equal to the preset value.
